(19) United States
(12) Patent Application Publication
(10) Pub. No.: US 2025/0320383 A1
(43) Pub. Date: Oct. 16, 2025

(54) MULTI-LAYER STRUCTURES COMPRISING SILANE COUPLING AGENTS

(71) Applicant: Dow Global Technologies LLC, Midland, MI (US)

(72) Inventors: Wenke Miao, Shanghai (CN); Shijie Ren, Shanghai (CN); Qiangqiang Yan, Shanghai (CN); Hongyu Chen, Shanghai (CN)

(73) Assignee: Dow Global Technologies LLC, Midland, MI (US)

(21) Appl. No.: 18/717,045

(22) PCT Filed: Dec. 10, 2021
(86) PCT No.: PCT/CN2021/137003

§ 371 Date: Jun. 6, 2024

(51) Int. Cl. C09J 5/02; C09J 7/30; C09J 11/06; C23F 11/173

(52) U.S. Cl. CPC C09J 5/02; C09J 7/30; C09J 11/06; C23F 11/173; C09J 2301/414; C09J 2400/166; C09J 2427/008

(57) ABSTRACT

The present disclosure provides embodiments of multi-layer structures and methods of making, the multi-layer structures comprising at least one polyvinyl chloride (PVC) layer, at least one metal layer, and at least one tie layer adhering the steel layer to the PVC layer, wherein the tie layer comprises: 0 to 95 wt. % of at least one ethylene acrylate copolymer; and 5 to 100 wt. % of terpolymer, wherein the multi-layer structure includes silane coupling agent is disposed in the tie layer, added as a primer, or both.

### TECHNICAL FIELD

Embodiments described herein generally relate to multi-layer structures, and specifically relate to multi-layer structures comprising silane coupling agents.

### BACKGROUND

Polyvinyl chloride (PVC) is the world's third-most widely produced synthetic plastic polymer (after polyethylene and polypropylene). Due to its good performance e.g., flame retardancy, mechanical strength, corrosion resistance, heat resistant, foamability, etc., PVC has been widely used in building materials, flooring, artificial leather, pipe, wire and cable, non-food packing, bottles, foam materials, sealants, fibers, etc.

Anti-corrosion panels are applied as roofing and walls for various industrial facilities where anti-corrosion is highly required. PVC may be utilized for the construction of anti-corrosion panel by the lamination of PVC onto metal using binder. However, for solvent free binders, the adhesion onto PVC is by polar or secondary valence bonding instead of covalent bonds, so the bonding at high temperature (>80° C.) is still a challenge. Accordingly, improved bonding for PVC to metal is required in anti-corrosion panel.

### SUMMARY

Embodiments of the present disclosure meet those needs by using silane coupling agents which provides adhesion by increasing the polarity and reactivity of the PVC substrate surfaces meanwhile forming chemical bonds with binder layer or on the formation of an interlayer between substrate and binder.

Embodiments incorporating silane coupling agents can be employed either in the form of a primer for pretreating PVC, or as an additive compounded/soaked into the tie layer resins. Due to the silane coupling agent in the tie layer or added as a primer on the tie layer, chemical reactions are trigged to form covalent bonds between PVC and tie layer. This tie layer, which bonds to the PVC may also bond with the metal layer (e.g., steel). Alternatively, another layer (for example, another tie layer comprising maleic anhydride grafted polyethylene resins) may be used to assist in the bonding with the metal layer. This tie layer package possesses good bonding performance at high temperatures.

According to at least one embodiment of the present disclosure, a multi-layer structure is provided. The multi-layer structure comprises at least one polyvinyl chloride (PVC) layer, at least one metal layer, and at least one tie layer adhering the steel layer to the PVC layer. The tie layer comprises: 0 to 95 wt. % of at least one ethylene acrylate copolymer, wherein the acrylate is selected from vinyl acetate, alkyl acrylate, or maleic anhydride mono ester; and 5 to 100 wt. % of terpolymer represented by the formula of E/V/W, wherein E is ethylene, V is an acrylic ester commoner selected from vinyl acetate, alkyl acrylate, or maleic anhydride mono ester, and W is a functional group selected from an epoxy, maleic anhydride, and a carboxyl group. The multi-layer structure includes silane coupling agent disposed in the tie layer, applied as a primer layer onto the PVC layer, or both, wherein the silane coupling agent comprises a structure of Z—(CH₂)n—SiX_{q}Y_{3-q}, where n=1-16; X═CH₃₀ or C₂H₅O—; q=1,2, or 3; Y═H, C₁-C₂₀ alkyl, aryl, CH₃OH—or C₂H₅O—; Z═H₂N—, CH₂═CH—, CH₂═C(CH₃)—COO—, Epoxy —CH₂O, NH—, OH—, or HS—.

These and other embodiments are described in more detail in the following Detailed Description.

### DETAILED DESCRIPTION

Specific embodiments of the present application will now be described. These embodiments are provided so that this disclosure will be thorough and complete and will fully convey the scope of the subject matter to those skilled in the art.

The term “polymer” refers to a polymeric compound prepared by polymerizing monomers, whether of a same or a different type. The generic term polymer thus embraces the term “homopolymer,” which usually refers to a polymer prepared from only one type of monomer as well as “copolymer,” which refers to a polymer prepared from two or more different monomers. The term “interpolymer,” as used herein, refers to a polymer prepared by the polymerization of at least two different types of monomers. The generic term interpolymer thus includes a copolymer or polymer prepared from more than two different types of monomers, such as terpolymers.

“Polyethylene” or “ethylene-based polymer” shall mean polymers comprising greater than 50% by mole of units derived from ethylene monomer. This includes ethylene- based homopolymers or copolymers (meaning units derived from two or more comonomers). Common forms of ethylene-based polymers known in the art include, but are not limited to, Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE).

The term “propylene-based polymer,” or “polypropylene” as used herein, refers to a polymer that comprises, in polymerized form, refers to polymers comprising greater than 50% by mole of units which have been derived from propylene monomer. This includes propylene homopolymer, random copolymer polypropylene, impact copolymer polypropylene, propylene/α-olefin copolymer, and propylene/α-olefin copolymer.

The term “LLDPE,” includes resin made using Ziegler-Natta catalyst systems as well as resin made using single-site catalysts, including, but not limited to, bis-metallocene catalysts (sometimes referred to as “m-LLDPE”), phosphinimine, and constrained geometry catalysts, and resins made using post-metallocene, molecular catalysts, including, but not limited to, bis(biphenylphenoxy) catalysts (also referred to as polyvalent aryloxyether catalysts). LLDPE includes linear, substantially linear, or heterogeneous ethylene-based copolymers or homopolymers. LLDPEs contain less long chain branching than LDPEs and include the substantially linear ethylene polymers, which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and blends thereof (such as those disclosed in U.S. Pat. Nos. 3,914,342 and 5,854,045). The LLDPE resins can be made via gas-phase, solution-phase, or slurry polymerization or any combination thereof, using any type of reactor or reactor configuration known in the art.

Reference will now be made in detail to embodiments of multi-layer structures as described herein. Embodiments of the multi-layer structure may include at least one polyvinyl chloride (PVC) layer, at least one metal layer, and at least one tie layer adhering the metal layer to the PVC layer. The tie layer comprises 0 to 95 wt. % of at least one ethylene acrylate copolymer, wherein the acrylate is selected from vinyl acetate, alkyl acrylate, or maleic anhydride mono ester. The tie layer also comprises 5 to 100 wt. % of terpolymer represented by the formula of E/V/W, wherein E is ethylene, V is an acrylic ester commoner selected from vinyl acetate, alkyl acrylate, or maleic anhydride mono ester, and W is a functional group selected from an epoxy, maleic anhydride, and a carboxyl group.

Additionally, the multi-layer structure includes silane coupling agent disposed in the tie layer, applied as a primer layer onto the PVC layer, or both, wherein the silane coupling agent comprises a structure of Z—(CH₂)n—SiX_{q}Y_{3-q}, where n=1-16; X═CH₃O or C₂H₅O—; q=1,2, or 3; Y═H, C₁-C₂₀ alkyl, aryl, CH₃OH—or C₂H₅O—; Z═H₂N—, CH₂═CH—, CH₂═C(CH₃)—COO—, Epoxy —CH₂O, NH—, OH—, or HS—.

The metal layer may comprise various materials familiar to the skilled person. For example, the metal layer may comprise steel or aluminum. In a specific embodiment, the metal layer may comprise steel.

As stated above regarding the tie layer, the ethylene acrylate copolymer may comprise alkyl acrylate. In one or more embodiments, the alkyl acrylate comprises methyl acrylate, methacrylate, ethyl acrylate, or n-butyl acrylate, or isobutyl acrylate.

The ethylene acrylate may comprise from 0.1 to less than 50 wt. % acrylate monomer, from 1 to 40 wt. % acrylate monomer, from 5 to 30 wt. % acrylate monomer, from 10 to 30 wt. % acrylate monomer, or from 15 to 25 wt. % acrylate monomer.

The tie layer may comprise from 0 to 95 wt. % of the at least one ethylene acrylate copolymer, from 5 to 90 wt. %, from 10 to 80 wt. %, from 25 to 75 wt. %, from 50 to 75 wt. %, or from 25 to 50 wt. % ethylene acrylate copolymer.

The ethylene acrylate copolymer may comprise a density from 0.900 to 0.975 grams/cubic centimeter (g/cc), from 0.925 to 0.975 g/cc, or from 0.930 to 0.950 g/cc. The ethylene acrylate copolymer may comprise a melt index (I₂) of 0.5 to 40 g/10 mins. as measured according to ASTM D1238 (2.16 kg/190° C.), from 1 to 10 g/10 mins, from 1 to 5 g/10 mins, or from 1.5 to 3.5 g/10 mins. Moreover, the ethylene acrylate copolymer may have a melting temperature of 80 to 100° C., 85 to 95° C., or from 90 to 94° C. as measured according to ASTM D3418.

Moreover, as stated above, the tie layer may comprise 5 to 100 wt. % of terpolymer represented by the formula of E/V/W. The ethylene monomer E may be present in an amount of at least 50 wt. % to 99 wt. % within the terpolymer, from 55 wt. % to 90 wt. %, from 60 to 85 wt. %, from 65 to 80 wt. %, or from 70 to 80 wt. % within the terpolymer.

Further as stated above, the acrylic ester commoner V is selected from vinyl acetate, alkyl acrylate, or maleic anhydride mono ester. In a specific embodiment, the monomer V may comprise vinyl acetate. The acrylic ester commoner V may be present in an amount from 0.1 to 50 wt. %, from 1 wt. % to 45 wt. % within the terpolymer, from 5 wt. % to 30 wt. %, from 5 to 25 wt. %, from 10 to 25 wt. %, or from 10 to 20 wt. % within the terpolymer.

The W functional group comonomer is selected from an epoxy, maleic anhydride, and a carboxyl group. In one or more embodiments, the epoxy monomer comprises glycidyl methacrylate. The W functional group may be present in an amount may be present in an amount from 0.1 to 50 wt. %, from 1 wt. % to 45 wt. % within the terpolymer, from 2 wt. % to 30 wt. %, from 3 to 20 wt. %, or from 5 to 10 wt. % within the terpolymer.

The terpolymer may comprise a density from 0.925 to 0.975 grams/cubic centimeter (g/cc), from 0.930 to 0.970 g/cc, or from 0.940 to 0.960 g/cc. The terpolymer may comprise a melt index (I₂) of 0.5 to 20 g/10 mins. as measured according to ASTM D1238 (2.16 kg/190°° C.), from 2 to 15 g/10 mins, from 4 to 10 g/10 mins, or from 7 to 9 g/10 mins. Moreover, the terpolymer may have a melting temperature of 70 to 100° C., 75 to 90° C., or from 80 to 85° C. as measured according to ASTM D3418.

In one or more embodiments, the tie layer comprises both the ethylene acrylate copolymer and the terpolymer. In one embodiment, the tie layer may comprise 5 to 95% wt.% of ethylene acrylate copolymer, and 5 to 95 wt. % of terpolymer. In further embodiments, the tie layer may comprise ethylene acrylate copolymer in an amount ranging from a lower limit of 5 wt. %, 10 wt. %, 20 wt. %, 30 wt. %, 40 wt. %, 50 wt. %, 60 wt. %, 70 wt. %, 80 wt. %, or 90 wt. % to an upper limit of 20 wt. %, 30 wt. %, 40 wt. %, 50 wt. %, 60 wt. %, 70 wt. %, 80 wt. %, 90 wt. %, or 95 wt. %. Similarly, the tie layer may comprise terpolymer in an amount ranging from a lower limit of 5 wt. %, 10 wt. %, 20 wt. %, 30 wt. %, 40 wt. %, 50 wt. %, 60 wt. %, 70 wt. %, 80 wt. %, or 90 wt. % to an upper limit of 20 30 wt. %, 40 wt. %, 50 wt. %, 60 wt. %, 70 wt. %, 80 wt. %, 90 wt. %, or 95 wt. %.

Moreover, the multi-layer structure may comprise a silane coupling agent having the Z—(CH₂)ₙ—SiX_{q}Y_{3-q}, where n=1-16; X═CH₃O or C₂H₅O—; q=1,2, or 3; Y═H, C₁-C₂₀ alkyl, aryl, CH₃OH—or C₂H₅O—; Z═H₂N—, CH₂═CH—, CH₂═C(CH₃)—COO—, Epoxy —CH₂O, NH—, OH—, or HS—. In further embodiments, the Z═H₂N—.

In specific embodiments, the silane coupling agent may comprise the structure of one or more of the following structures:

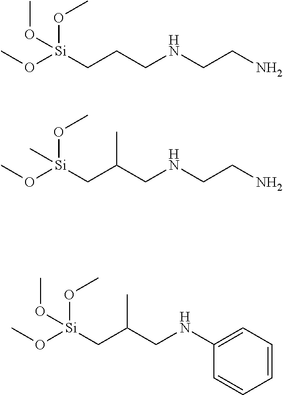 [SMILES: CO[Si](CCCNCCN)(OC)OC ; CO[Si](C)(CC(C)CNCCN)OC ; CO[Si](CC(C)CNc1ccccc1)(OC)OC]

Moreover, the silane coupling agent may comprise one or more alkoxysilanes, aminosilanes, or aminoalkoxysilanes. Furthermore, the silane coupling agent may comprise one or more of the following: (3-Aminopropyl) trimethoxysilane (CAS 13822-56-5); (3-Aminopropyl)triethoxysilane (CAS 919-30-2); 3-Aminopropyl(diethoxy)methylsilane (3179-76-8); N-[3-(Trimethoxysilyl)propyl] ethylenedia mine (CAS 1760-24-3); (3- ((2-Aminoethyl)amino)propyl)silanetriol (CAS 68400 Sep. 9); and 3-Triethoxysilylpropyl)ethylenediamine (CAS 5089-72-5).

As stated above, the silane coupling agent may be added as a primer layer, compounded into the tie layer, or both. When added as a primer layer, the silane coupling agent may be applied at an amount from 0.01 to 100 g/m², from 1 to 20 g/m², or from 5 to 10 g/m². Alternatively, when compounded in the tie layer, tie layer comprises from 0.01 to 10 wt. %, from 0.5 to 7.5 wt. %, or from 1 to 5 wt. % silane coupling agent.

Various applications are contemplated for the present multi-layer structures. As sated above, multi-layer structures may be incorporated into anti-corrosion panels.

### Optional Ingredients

Various optional ingredients are considered possible for the multi-layer structures. For example, the multi-layer structures may comprise antioxidant (AO). These AO may include but are not limited to: hindered phenolic AO such as IRGANOX 1010 (CAS No. 6683-19-8), IRGANOX 1024 (CAS No. 32687-78-8), IRGANOX 1035 (CAS No. 41484-35-9), IRGANOX 1076 (CAS No. 2082-79-3), IRGANOX 1098 (CAS No. 23128-74-7), IRGANOX 1135 (CAS No. 125643-61-0), IRGANOX 259 (CAS No. 35074-77-2), IRGANOX 1330 (CAS No. 1709-70-2), IRGANOX 3114 (CAS No. 27676-62-6), IRGANOX 565 (CAS No. 991-84-4), IRGANOX 245 (CAS No. 36443-68-2), IRGANOX 3052 (CAS No. 61167-58-6), IRGANOX 3790 (CAS No. 40601-76-1), IRGANOX 1520 (CAS No. 110553-27-0), IRGANOX 1726 (CAS No. 110675-26-8); phosphite AO including IRGAFOS 168 (CAS No. 31570 Apr. 4), IRGAFOS 38 (CAS No. 145650-60-8), IRGAFOS 12 (CAS No. 80410-33-9), IRGAFOS TNPP (CAS No. 26523-78-4); thioether AO such as IRGANOX PS 800 (CAS No. 123-28-4), IRGANOX PS 802 (CAS No. 693-36-7), or the combinations of more than two AO among them.

Additional polymer materials are contemplated for use in the multi-layer structures. For example, the multi-layer structures may comprise one or more of polymethyl methacrylate (PMMA), HDPE, LLDPE, polyolefin elastomer (POE), polypropylene, ethylene-propylene copolymer, and combinations thereof.

Moreover, the tie layer may optionally comprise up to 1 wt. % nonionic wetting agent, which may be added when the silane is dissolved into water before applying as a primer.

### Method of Making

Various methodologies are considered suitable for preparing the present multi-layer structures. For example, the silane coupling agent may be compounded with the polymer resin in the tie layer using various blend and pre-blending techniques. For example, the compounding may involve a soaking process (e.g., by blending silane with resins and shaking at lower than melting temperature for several hours), blending with a twin screw extruder, blending with a BUSS kneader, blending with a single screw extruders, blending with a batch mixer, etc. Additionally, when added into the tie layer film, the tie layer film may be produced using blown film technology or casting film technology.

When applying the silane coupling agent as a primer layer, the primer layer can be coated via spray coating, roller coating, or immersing PVC surface into a silane solution.

### TEST METHODS

### 180° Peel Strength Test

The 180° Peel Strength Test was conducted on an Instron machine equipped with an environmental cabinet according ASTM D1876. The samples were heated at 50° C. and then pulled at 100 mm/min until break.

### Density

Density was measured according to ASTM D792-13 and is reported in grams per cubic centimeter (g/cm³).

### Melt Index (I₂)

Melt index (I₂) was measured according to ASTM D 1238-13 using conditions of 190° C./2.16 kilograms (kg). Results were reported in units of grams eluted per 10 minutes (g/10 min.).

### EXAMPLES

The following examples illustrate features of the present disclosure but are not intended to limit the scope of the disclosure. The following experiments analyzed the performance of embodiments of multi-layer structures described herein.

### Materials Used

The PVC film was supplied by Sinopharm Chemical Reagent Co., Ltd (SCRC) and has the following dimensions thickness of 100 μm and width of 1 m.

Tie resin 1 is an ethylene methacrylate copolymer comprising 24 wt. % methacrylate comonomer. Tie resin 1 has a melt index (I₂) of 2 g/10 mins. as measured according to ASTM D1238 (2.16 kg/190° C.).

Tie resin 2 is a terpolymer comprised of: ethylene monomer, 15 wt. % vinyl acetate (VA) comonomer; and 9 wt. % glycidyl methacrylate (GMA) comonomer. Tie resin 2 has a melt index (I₂) of 8 g/10 mins. as measured according to ASTM D1238 (2.16 kg/190° C.).

Tie Resins 1 and 2 may be prepared by standard free-radical copolymerization methods, using high pressure, operating in a continuous manner. Monomers are fed into the reaction mixture in a proportion, which relates to the monomer's reactivity, and the amount desired to be incorporated. In this way, uniform, near-random distribution of monomer units along the chain is achieved. Polymerization in this manner is well known, and is described in U.S. Pat. No. 4,351,931 (Armitage), which is hereby incorporated by reference. Other polymerization techniques are described in U.S. Pat. No. 5,028,674 (Hatch et al.) and U.S. Pat. No. 5,057,593 (Statz), both of which are also hereby incorporated by reference.

The silane coupling agents used in the Experiments are listed in Table 1 below.

TABLE 1
Silane coupling agents

| Name | Chemical Name | Chemistry and function |
|---|---|---|
| Silane 1 | (3-Aminopropyl)trimethoxysilane | Aminosilane coupling agent |
| | (CAS 13822-56-5) | |
| Silane 2 | (3-Aminopropyl)triethoxysilane | Aminosilane coupling agent |
| | (CAS 919-30-2) | |
| Silane 3 | 3-Aminopropyl(diethoxy)methylsilane | Aminosilane coupling agent |
| | (CAS 3179-76-8) | |
| Silane 4 | N-[3- | Aminosilane coupling agent |
| | (Trimethoxysilyl)propyl]ethylenediamine | |
| | (CAS 1760-24-3) | |
| Silane 5 | (3-((2-Aminoethyl)amino)propyl)silanetriol | Hydroly zed aminosilane coupling agent |
| | (CAS 68400-09-9) | |
| SCA-613* | 3-Triethoxysilylpropyl)ethylenediamine | Amino silane coupling agent |
| | (CAS 5089-72-5) | |

*Supplied by Guotai Huarong New Chemical Materials Co., Ltd.

### Sample Preparation Process

### Compounding

Referring to the samples of Tables 2 and 3, the Tie resin 1 and Tie resin 2were fed into a Brabender mixer at 150° C. wherein the rotor speed was set at 40 rpm until the polymers melt. The resin mixture was rotated at 40 rpm for another 5 min. The compound was then cut into small pieces for further use

### Film Preparation

Small pieces of compound was then placed between two Mylar sheets before being sandwiched in a hot press machine and preheated at 150° C. for 10 min. The pressed compound was vented eight (8) times, then was held at 150° C. and 10 MPa (pressure between upper and lower plates of hot press machine) for another 5 min. Next, the film was cooled to room temperature within 5 mins at 10 MPa pressure. The film thickness for all of the film samples of table was 100 μm.

Laminate preparation

The films were sandwiched between two (2) pieces of PVC film with dimensions of 10 cm X 10 cm. Prior to be being sandwiched, the silane composition or Tables 2 and 3 were added as a primer layer onto the PVC film. Specifically, the silane composition was diluted by solvent (ethanol) to produce 2 wt. % silane solutions. The silane solutions are coated onto the PVC surface and then dried at 60° C. for 3 mins to remove the solvent. The loading of silane was calculated as following Equation 1:

$$W = ( W 2 - W 1 ) * 100 ; \qquad Equation 1$$

Where: W is the silane loading (gram/m²); W1 is the weight of 10×10 cm² of PVC film; W2 is the total weight of PVC and dried silane primer.

Then the primed PVC samples were laminated at a temperature of 180° C. and a pressure of 0.8 MPa for 10 seconds. The laminated sheets, which are listed in Table 2 and 3, were cut into specimens of 10 cm×2.5 cm for further testing. Peel strength results are provided below.

TABLE 2
Peel Strength of laminates with and without silane primer

| Component | SI Unit | CE-1 | IE-1 | IE-2 | IE-3 | IE-4 | IE-5 | IE-6 |
|---|---|---|---|---|---|---|---|---|
| Tie resin 2 | Wt. % | 100 | 100 | 100 | 100 | 100 | 100 | 100 |
| Silane 1 | g/m² | | 5~10 | | | | | |
| Silane 2 | g/m² | | | 5~10 | | | | |
| Silane 3 | g/m² | | | | 5~10 | | | |
| Silane 4 | g/m² | | | | | 5~10 | | |
| Silane 5 | g/m² | | | | | | 5~10 | |
| Silane SCA-613 | g/m² | | | | | | | 5~10 |
| 180° Peel strength | (N/mm) | 0.42 ± 0.03 | >2.0 | >2.0 | >2.0 | >2.0 | >2.0 | 1.78 ± 0.16 |
| @ 50° C. | | | | | | | | |
| Note | | Adhesive | PVC | PVC | PVC | PVC | PVC | Cohesive |
| | | failure | broke | broke | broke | broke | broke | failure |

CE—Comparative Example
IE—Inventive Example

Referring to Table 2, Comparative Example 1 (CE-1), which includes Tie Resin 2 without the priming of silane, exhibited a 180° peel strength of 0.42±0.03 N/mm at 50° C. In contrast, the Inventive Examples (IE), which were primed with silane, demonstrated peel strengths of 1.78 N/mm or greater. From a qualitative standpoint, most of the IE samples show resulted in the PVC being broken or cohesive failure.

TABLE 3
Peel Strength data of laminates comprising tie layer
polymer blends with and without silane primer

| | | | Silane 4 | 180° Peel strength |
|---|---|---|---|---|
| Component | Tie resin 1 (wt. %) | Tie resin 2 (wt. %) | (g/m² of Primer) | @ 50° C. (N/mm) |
| IE-7 | 90 | 10 | 5~10 | 1.55 ± 0.02 |
| IE-8 | 70 | 30 | 5~10 | 1.56 ± 0.21 |
| CE-2 | 50 | 50 | — | 0.98 ± 0.15 |
| IE-9 | 50 | 50 | 5~10 | 1.46 ± 0.12 |
| CE-3 | 30 | 70 | — | 0.68 ± 0.04 |
| IE-10 | 30 | 70 | 5~10 | 1.49 ± 0.12 |
| CE-4 | 10 | 90 | — | 0.54 ± 0.05 |
| IE-11 | 10 | 90 | 5~10 | 1.52 ± 0.07 |
| CE-5 | 5 | 95 | — | 0.63 ± 0.08 |
| IE-12 | 5 | 95 | 5~10 | 1.89 ± 0.04 |

Table 3 shows the peel strength of blends of Tie resin 2 and Tie resin 1 with and without silane primer. As shown, all the IE samples demonstrate higher peel strength than none primed CE samples, showing the advantages of the tie layer-silane primer.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

1. A multi-layer structure comprising at least one polyvinyl chloride (PVC) layer, at least one metal layer, and at least one tie layer adhering the steel layer to the PVC layer,
wherein the tie layer comprises:
0 to 95 wt. % of at least one ethylene acrylate copolymer, wherein the acrylate is selected from vinyl acetate, alkyl acrylate, or maleic anhydride mono ester; and
5 to 100 wt. % of terpolymer represented by the formula of E/V/W, wherein E is ethylene, V is an acrylic ester commoner selected from vinyl acetate, alkyl acrylate, or maleic anhydride mono ester, and W is a functional group selected from an epoxy, maleic anhydride, and a carboxyl group;
wherein the multi-layer structure includes silane coupling agent disposed in the tie layer, applied as a primer layer onto the PVC layer, or both, wherein the silane coupling agent comprises a structure of Z—(CH₂)ₙ—SiX_{q}Y_{3-q}, where n=1-16; X═CH₃O or C₂H5O—; q=1,2, or 3; Y═H, C₁-C₂₀ alkyl, aryl, CH₃OH—or C₂H₅O—; Z═H₂N—, CH₂═CH—, CH₂═C(CH₃)—COO—, Epoxy —CH₂O, NH—, OH—, or HS—.

2. The multi-layer structure of claim 1, wherein the silane coupling agent comprises the structure of

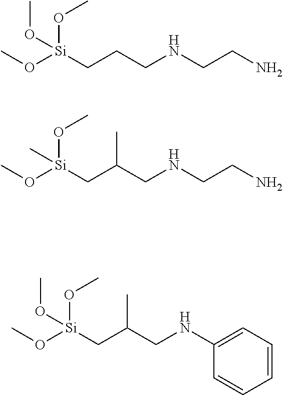 [SMILES: CO[Si](CCCNCCN)(OC)OC ; CO[Si](C)(CC(C)CNCCN)OC ; CO[Si](CC(C)CNc1ccccc1)(OC)OC]

3. The multi-layer structure of claim 1, wherein the metal layer comprises steel or aluminum.

4. The multi-layer structure of claim 1, wherein the silane coupling agent is in the primer layer.

5. The multi-layer structure of claim 4, wherein the primer layer is applied at an amount of 0.01 to 100 g/m².

6. The multi-layer structure of claim 1, wherein the silane coupling agent is compounded in the tie layer.

7. The multi-layer structure of claim 6, wherein the tie layer comprises from 0.01 to 10 wt. % silane coupling agent.

8. The multi-layer structure of claim 1, wherein Z═H₂N—.

9. The multi-layer structure of claim 1, wherein the alkyl acrylate comprises methyl acrylate, methacrylate, ethyl acrylate, or n-butyl acrylate or isobutyl acrylate.

10. The multi-layer structure of claim 1, wherein the ethylene acrylate copolymer comprises from 0.1 to less than 50 wt. % acrylate.

11. The multi-layer structure of claim 1, wherein the epoxy monomer comprises glycidyl methacrylate.

12. The multi-layer structure of claim 1, wherein the terpolymer comprises from 0.1 to 50 wt. % of acrylic ester comonomer V.

13. The multi-layer structure of claim 1, wherein the terpolymer comprises from 0.1 to 50 wt. % of functional group W.

14. The multi-layer structure of claim 1, wherein the tie layer comprises 5 to 95% wt.% of ethylene acrylate copolymer, and 5 to 95 wt. % of terpolymer.

15. An anti-corrosion panel comprising any of the multi-layer structures of claim 1.
